(19) United States
(12) Patent Application Publication
(10) Pub. No.: US 2013/0064521 A1
(43) Pub. Date: Mar. 14, 2013

(54) Session recording with event replay in virtual mobile management

(71) Applicants: Deepak Gonsalves, Bridgewater, NJ (US); Calvin Charles, Piscataway, NJ (US); Deepa Jagannatha, Somerset, NJ (US); Ramesh Parmar, Scotch Plains, NJ (US); Byung Joon Oh, Piscataway, NJ (US); Subramanyam Ayyalasomayajula, Kendall Park, NJ (US)

(72) Inventors: Deepak Gonsalves, Bridgewater, NJ (US); Calvin Charles, Piscataway, NJ (US); Deepa Jagannatha, Somerset, NJ (US); Ramesh Parmar, Scotch Plains, NJ (US); Byung Joon Oh, Piscataway, NJ (US); Subramanyam Ayyalasomayajula, Kendall Park, NJ (US)

(21) Appl. No.: 13/606,113

(22) Filed: Sep. 7, 2012

Related U.S. Application Data
(60) Provisional application No. 61/532,964, filed on Sep. 9, 2011.

(51) Int. Cl. H04N 5/775

(52) U.S. Cl. 386/230; 386/E05.002

(57) ABSTRACT

Systems and methods for recording and replaying a troubleshooting event between a customer and CARE agent are provided. The method includes configuring a communication component of the remote mobile management systems to enable recording of a media stream associated with entire troubleshooting session; transmitting the media stream over a network based on the configuration of the communication component; receiving the media stream over the network; and replaying the received media stream. As a result, a special mode of Virtual Mobile Management (VMM) tool that allows remote support technicians to record the entire troubleshooting session from the management console is provided by present invention and they can replay the events to help trace the problems encountered by the user on the device.

### CROSS-REFERENCE TO RELATED APPLICATION

This application is related to U.S. patent application Ser. No. 12/426,555, filed on Apr. 20, 2009, and U.S. patent application Ser. No. 12/550,742, filed on Aug. 31, 2009. In addition, this application claims the priority date of U.S. Provisional Patent Application No. 61/532,964, filed Sep. 9, 2011, and entitled “Session Recording with Event”, the contents of which is incorporated herein by reference.

### FIELD OF INVENTION

The present invention relates to mobile wireless communication devices, systems, networks, and methods of operation. This invention describes remote management of the mobile devices. This invention is about recording the entire troubleshooting event including the key taps or key press events and screen display that can be replayed at a later stage for recreating the scenario.

### BACKGROUND OF THE INVENTION

At times, there are instances when the CARE Representative who is performing the VMM (Virtual Mobile Management) would not be able to resolve a subscriber's situation. In those instances, it would be beneficial to have a recorded session that can be examined/investigated by another technical support person so as to resolve the issue.

Additionally, there might be a need to train the CARE Representatives on certain aspects of VMM and therefore it would be best to have a recorded session to be able to be shown for training and evaluation purposes.

Generally, Virtual Management systems exist for the main purpose of providing aid to a user in troubleshooting desktop and laptop computers. Recording and replaying operations in a computer environment are important for self-care event replay helps to record the display navigation, key and touch steps/events on a device by the user to reproduce a problem and to send it to the communication server which will create a ticket and forward the ticket to an available Customer Support Representative (CSR). What is lacking in the art is an event replay for Virtual Mobile Management, capable of providing user support personnel event history of a mobile device.

### SUMMARY OF THE INVENTION

This invention describes remote management of the mobile devices. This invention is about recording the entire troubleshooting event including the key taps or key press events and screen display that can be replayed at a later stage for recreating the scenario. The current invention is a special mode of Virtual Mobile Management (VMM) tool that allows a remote support technician to record the entire troubleshooting session from the management console and replay the events to help trace the problems encountered by the user on the device. In one embodiment, the current invention is a special mode of Virtual Mobile Management (VMM) tool that allows a remote support technician to record the entire troubleshooting session from the management console and replay the events to help trace the problems encountered by the user on the device.

Self-care event replay helps to record the display navigation, key and touch steps/events on a device by the user to reproduce a problem and to send it to the communication server which will create a ticket and forward the ticket to an available CSR. The CSR can analyze the captured display navigation, key and touch events along with the other device information and can establish a virtual mobile management session with the device to fix the issue or can generate a script for remote execution on the device for troubleshooting.

An objective of the invention is to benefit support admin through the ability to record the entire event and replay the same at a later stage.

Another objective of this invention is to provide an improved method and apparatus for recording the entire troubleshooting that includes the key taps or key press events and screen display.

Another objective of this invention is to offer a method and apparatus for replicating how to figure out some problems by a Customer Support Representative (CSR).

Still another objective of this invention is to support a method and apparatus for generating a script for remote execution on the device for troubleshooting by a CSR.

Another objective of the invention is to benefit CSR through the ability to observe activity on a user's mobile device which allows support personnel to quickly pinpoint the source of a user's problem and provide proper instructions to the user.

Yet another objective of the invention is to benefit CSR through the ability to take control of a user's mobile device remotely allows support personnel to quickly assist without having the user to bring the device into a repair facility.

Still another objective of the invention is to benefit CSR through the task of establishing a remote session with a mobile device through a desktop computer transparent to the end user.

Yet still objective of the invention is to benefit CSR by not connecting to a device but since the entire event is recorded the customer support representative can replay the session events.

Another objective of the invention is to allow operators to validate the device performance and perform a device audit.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a schematic illustration of the overall architecture;

FIG. 2 is a flow diagram of a use case scenario;

FIG. 3 is a flow diagram that illustrates an operation of a recording session event;

FIG. 4 is a flow diagram that illustrates stopping a record session event;

FIG. 5 is a flow diagram that illustrates a store and retrieve session event;

FIG. 6 is a flow diagram that illustrates bearer and signal links status; and

FIG. 7 is a protocol diagram.

### DETAILED DESCRIPTION OF THE INVENTION

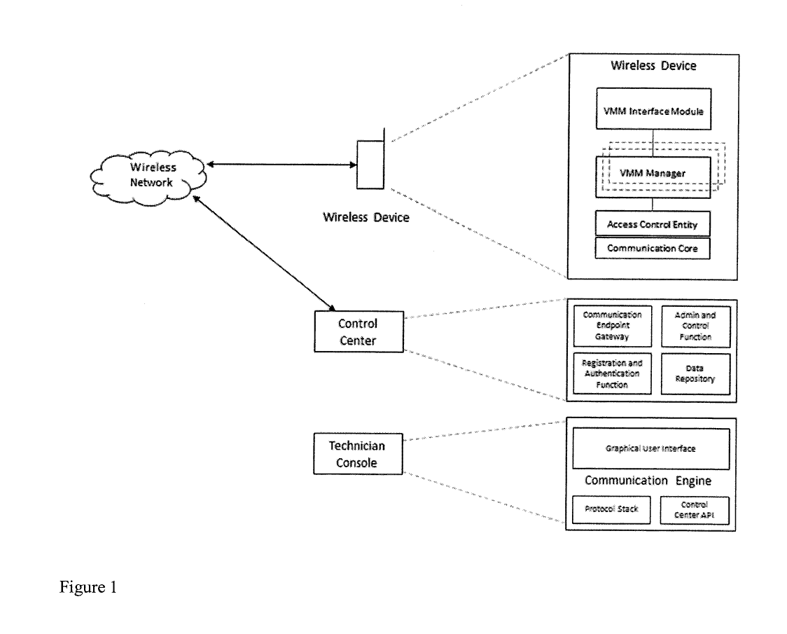

FIG. 1 is a schematic illustration of overall architecture about virtual mobile management in the following: The system of invention comprises multiple components to support the customer care use cases. The system of invention has a high-performance, fault-tolerant and highly secure architecture that is capable of supporting thousands of active remote control sessions concurrently as well as hundreds of thousands of devices enrolling automatically at the same time. The system is scalable to handle millions of device registrations and storing relevant device data for configurable retention period. The key components of the system of invention include: Communication End Point Gateway (CEG) Server; Admin and Control Server; Registration and Authentication Server; Technician Console; Data Repository Server and Wireless Mobile Device.

The primary responsibility of the Communication End Point Gateway, also referred to as the mediation server, is to manage the device connections within the system. The mediation server provides communication endpoints between Control Center (Technician Console, Admin and Control Function) and a device. The mediation server allows for multiple requests to be serviced within one session from multiple consoles. The mediation server further provides a consistent manner of device connection and Tool service in a system with heterogeneous devices running different operating systems, and provides load balancing across multiple Connection Handlers on each CEG Server in order to minimize single point of failure.

The CEG server has a connection monitor and a connection handler. The collection monitor creates and manages connection handlers, creates Session ID for new connection request, and monitors all the scheduled and existing sessions. The Connection handler is setup for every Connection End Point Gateway, where the number of Connection Handlers is configurable. All the sessions are load distributed across the Connection Handler and each handler handles multiple device sessions.

The primary responsibility is to administer and manage all types of communication between the Control Center and the client devices is performed through an admin and control server.

The Administrative Service is designed to be central administration entity of the entire VMM system. Through this service, system administrators perform administration, management and instrumentation all the servers within the system, create and maintain multiple tenants, assign tenant administrator roles, etc.

The Management Service provides the operational end point to the system. The primary functions of Management Service are: Load distribution among the CEG; Management of device registration; Administration of devices, administration of users, zones, policies, roles, etc . . . ; and Session Queuing.

The Management Entity component is responsible in providing the Management service with an in-memory data store for key operational data such as Access Control List (ACL), user/group/zone structures, and so forth.

The Service Coordinator is responsible in coordinating the communication between various elements within the System. It provides the database interface to the Registration and Authentication Function in the Control Center. All services register themselves with this service. This service is responsible for service discovery.

The Registration and Authentication Server component provides a single point of entry for all devices for enrollment and authentication services during VMM session. The Registration and Authentication Server provides Registration Service during Auto-Enrollment wherein devices are required to register themselves with this service prior to enrolling themselves. An Enrollment Service is responsible to enroll registered devices with the system. A Software Update service manages the various client packages in the system, devices connect to this service to request for client update. If an update is available, the service will provide the appropriate client download link. A Device Management service provides the enrolled devices an interface to update its parameters in the system such as Mobile Directory Number (MDN) when the device detects a change. An Anchor Admin service provides the administration component.

The Session Queuing Manager takes all the incoming User Initiated VMM connection requests and stores them into the Session Queue Repository to be later processed by the Queue Processor. The Queue processor gets notified by the Session Queue Manager that a new incoming session is in the session repository. Queuing processor processes the session request, determines the device request and forwards it to the Queue Router. Queuing Router determines the corresponding dispatcher. The dispatcher schedules the request to be serviced by the echnician console. Finally the Technician console receives the request and authenticates the user and further proceeds with the VMM session.

The Technician Console provides a Graphical User Interface (GUI) to manage and control the Mobile Devices. The following provides list of functions that can be performed using the console include beginning pre-enrollment requests; managing all RD Mobile devices; servicing the infrastructure of the Control center, and performing administrative tasks and VMM.

A Data Repository Server stores all the information about the VMM-Mobile devices, server configuration, tasks and status settings. These databases are pivotal to configure and update managed devices and server components. It is also responsible to maintain the user login information as well as device authentication information. The Data Repository Server comprises of 3 database elements: An Admin DB maintains all the system configurations, tenant configuration and management information, system administration and server instrumentation data. This database is accessed by the System Admin Service. An Ops DB maintains data that is required for the operations of the system such as device enrollment, ACL, groups, users, zones, etc. This database is accessed by the Management Service and the Service Coordinator. A Reports DB contains historical data of device enrollment, session, audit, and report views, and the like.

A Mobile Client depending on the Mobile Device OS is comprised of a Remote Diagnostic Adapter also referred to as Stub, may not be required for some Device OS (e.g. Blackberry); and a Remote Diagnostics Mobile Application also referred to as Mobile Application. The Remote Diagnostics Mobile application requires access to display, key and touches events from the device. Some of the Device OS' may not provide Application Programming Interface (APIs) for these features. Therefore preloaded Remote Diagnostics Adapter is required to provide access to the display, key and touch events in a secure and robust manner to the RD Mobile application.

The key features that are required by RD Mobile application to manage devices remotely include a Display Capture which involves the capturing of device screen by the Remote Diagnostics Mobile application; a Key event Injection which involves the injection of key events into the device screen by the RD Mobile application; a Touch event injection that involves the simulation of touch events on the device screen by the RD Mobile application; and a Device Information like network, power status, Mobile Network Code (MNC), Mobile Country Code (MCC), International Mobile Equipment Identity (IMEI), International Mobile Subscriber Identity (IMSI), Electronic Serial Number (ESN), battery level of the smart phone etc., this is of value to the remote technician.

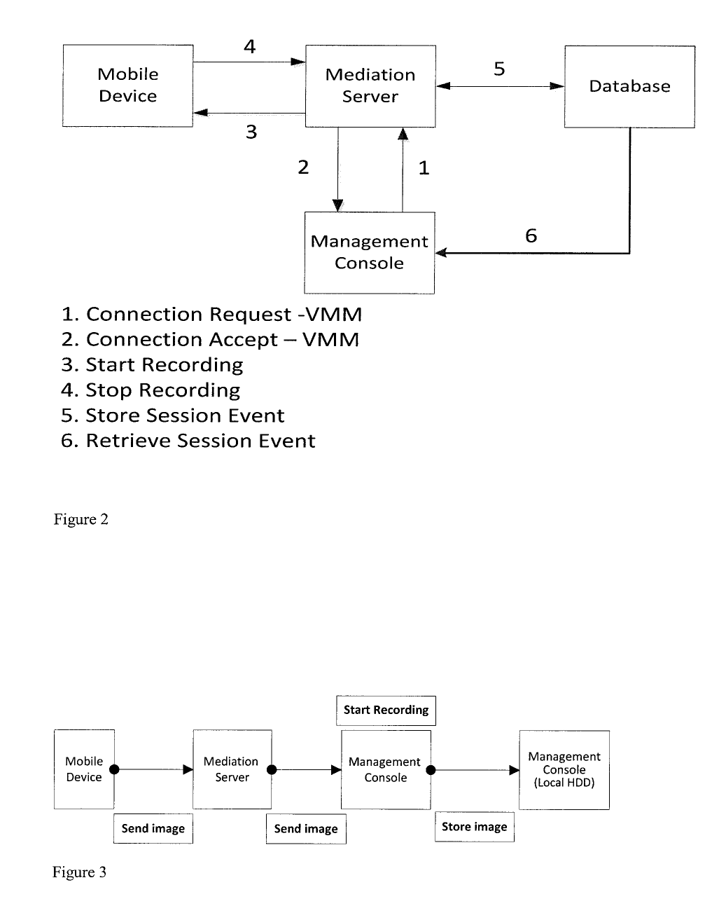

Now referring to FIG. 2, set forth is a flow diagram that illustrates an exemplary operation for recording and replaying an interaction between a mobile device and a management console using a database server as an optional session mode such as session record and replay in virtual mobile management. It is also a schematic diagram of an embodiment of a system in which session events can be recorded using a database server through mediation server.

FIGS. 3-5 presents a detailed time-sequence diagram such as start recording, stop recording, and store and retrieve session events.

Step 1: The Customer Support Representative connects to the mobile device to perform VMM.

Step 2: Connection Request sent to the mobile device from the Management Console.

Step 3: After connection is successful the session event recording will start. User can press any keys and do taps during the recording session and all the events will be captured.

Step 4: After the session ends the recorded event is stored in the database.

Step 5: Customer support representative can retrieve the recorded event from the database.

FIG. 3 is a flow diagram that illustrates an exemplary operation for recording session event from a mobile device storing image data in local HDD of management console once starting record event is happened at management console.

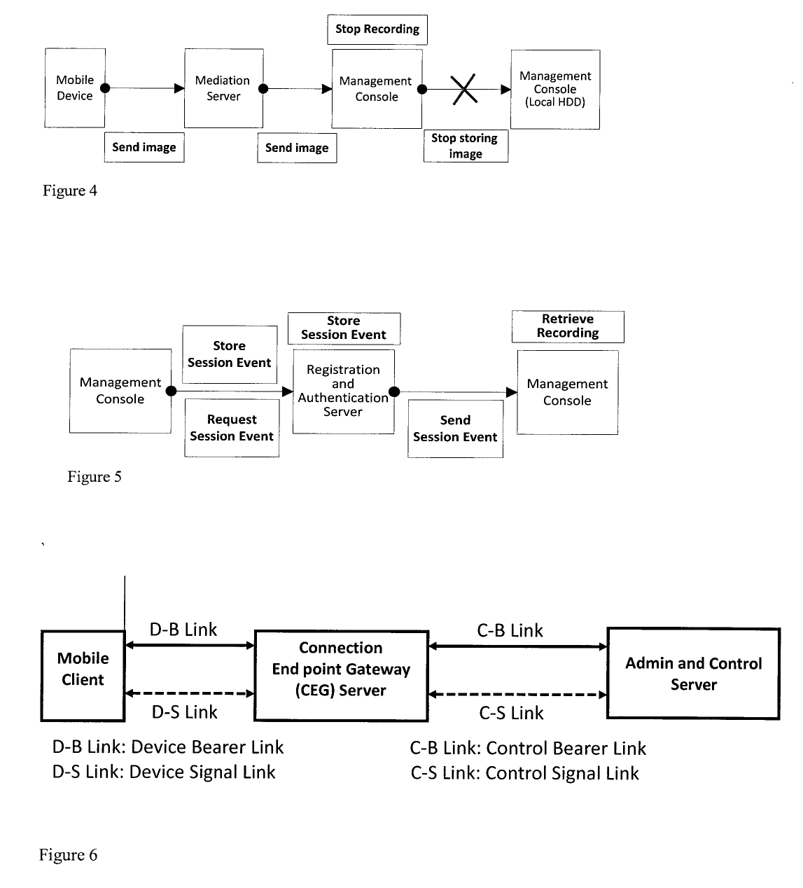

FIG. 4 is a flow diagram that demonstrates a representative operation for stopping record session event from a mobile device then, it is not stored the image data in local HDD of management console once stopping record event is happened at management console.

FIG. 5 is a flow sequence which achieves store and retrieve session events between management console and registration and authentication server so session event is stored by registration and authentication server then, if management console requests replaying session event to registration and authentication, registration and authentication server will transfer session event to management console.

FIG. 6 describes the bearer and signal links status to communicate between mobile device and admin and control server.

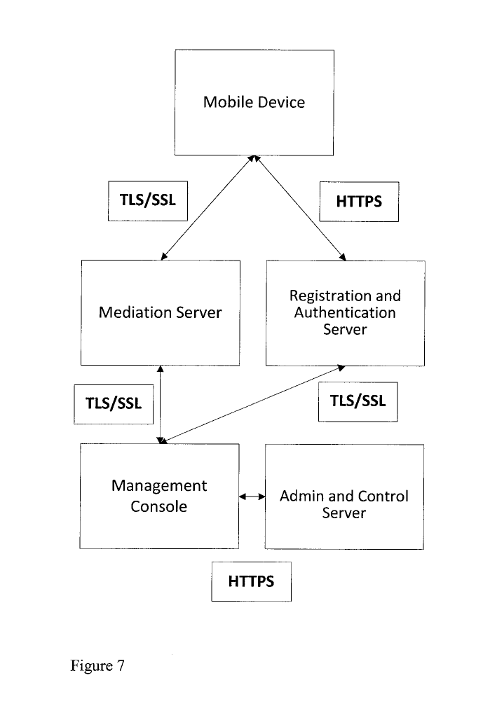

FIG. 7 presents the protocol diagram regarding what kinds of protocols are operated in this invention as HTTPS and TLS/SSL (Secure Sockets Layer/Transport Layer Security).

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A method of session recording with event replay for a wireless mobile device during a Virtual Mobile Management (VMM) comprising the steps of:
connecting of a Customer Support Representative to a wireless mobile device to perform VMM;
connection request sent to the mobile device from a management console;
recording of a troubleshooting session event upon successful connection;
storing the recording in a database server; and
replay of said stored recording;
wherein the Customer Support Representative can retrieve the stored recording and replay an interaction between the mobile device and the management console using the database server as an optional session mode to replay the troubleshooting session to help trace problems encountered by the user on the wireless mobile device.

2. The method of session recording during a VMM according to claim 1 wherein said stored recording includes captured user key, touch events, and display navigation.

3. The method of session recording during a VMM according to claim 1 including a step of configuring a communication component of the remote mobile management system to enable recording of a media stream associated with the troubleshooting session.

4. The method of session recording during a VMM according to claim 3 including the step of transmitting a media stream over a network based on the configuration of the communication component.

5. The method of session recording during a VMM according to claim 1 wherein said stored recording includes a detailed time-sequence diagram such as start recording, stop recording, and store and retrieve session events.

6. The method of session recording during a VMM according to claim 1 wherein the recording of a session is automatically operated by the VMM upon successful connection between the wireless mobile device and the management console.

7. The method of session recording during a VMM according to claim 1 wherein a script for remote execution on the wireless mobile device for troubleshooting is generated by the Customer Support Representative.

8. The method of session recording during a VMM according to claim 1 wherein said stored recording is analyzed by the Customer Support Representative.

9. The method of session recording during a VMM according to claim 1 including the step of storing image data in local HDD of the management console.

10. The method of session recording during a VMM according to claim 1 including the step of storing session events between the management console and a registration and authentication server.

11. The method of session recording during a VMM according to claim 1 wherein a communication protocol between the mobile device and the management console is TLS/SSL.

12. The method of session recording during a VMM according to claim 10 wherein a communication protocol between the mobile device and the registration and authentication server is HTTPS.
